(19) United States
(12) Patent Application Publication
(10) Pub. No.: US 2004/0266268 A1
(43) Pub. Date: Dec. 30, 2004

(54) Wideband filter installations and connections

(76) Inventors: Juan Tomas Arias, Madrid (ES); Jose Manuel Jorde, Valencia (ES)

Correspondence Address: MYERS BIGEL SIBLEY & SAJOVEC, PO BOX 37428, RALEIGH, NC, 27627, US

(21) Appl. No.: 10/469,627

(22) PCT Filed: Feb. 14, 2002
(86) PCT No.: PCT/GB02/00649

(30) Foreign Application Priority Data
Feb. 27, 2001 (GB) 0104766.1
Oct. 4, 2001 (ES) P 200102225

(51) Int. Cl. H01R 24/00

(52) U.S. Cl. 439/637

(57) ABSTRACT

In wideband filter installations and connections it is proposed to replace the conventional connection assembly for connecting the filter card (1′) to the corresponding wiring (7), by a single strip (8) with closed contacts. This allows the size of the frame (5′) to be significantly reduced and also allows the contact between the voice input and the corresponding output to be maintained in the event of a failure at the data input. In addition, the filter cards (1′) preferably are individual cards, for a single user, allowing to install them one-by-one on a multiple strip as the number of users increases.

### BACKGROUND OF THE INVENTION

The present invention relates to wideband filter installations and connections used in the field of telecommunications.

More specifically the present invention relates to telephone networks used by different operators which provide transmission services to different users or consumers, and is meant to simplify greatly circuit connections at the level of said wideband filters, with the resulting reduction in the volume of the cabins holding said circuits and in the cubicles which contain said cabins, while also allowing to enable and perform wideband connections in any area meant for distributors in charge of the distribution and operability of telephone lines.

There are several operators in the telecommunications sector which provide voice transmission services to different users or consumers, which requires a complex telephone network in which participate a number of electrical, mechanical, etc. components which allow to provide said service.

Essentially, in said telephone network participates a switching exchange in charge of providing the various signals and lines for voice utilisation, lines which are linked by long cable deployments to the respective horizontal and vertical distributors meant to allow the distribution and operability of said telephone lines, thus enabling the users to utilise the telephone network.

When data as well, and not only voice, are to be transmitted by a same operator, such as for video signals, Internet, etc. in a wide band a digital line access multiplexer is provided which receives voice signals from the horizontal distributors and wideband signals from the corresponding servers, such as an Internet server. Said multiplexer is complemented by filters or splitters which can add both signals and distribute them once again to the vertical distributors for transmission to the user. Before this signal is received by the user further filters or splitters are provided which separate the two signals, providing the user with a voice line and a wideband line.

In compliance with recent regulations, it has been established that the network on the street known as the customer loop may be shared by other operators. That is, a second operator must establish a similar system to that used by the same operator, utilising the cable deployed on the street belonging to the first operator.

When a second operator is established such operator must perform the same functions as were previously provided by the first operator, with sufficient independence to be able to use the voice signal provided by the first operator and the wideband signal received directly from the wideband server to the second operator, and be capable of providing the user with the same service using its own general structure, distributors, filters, etc.

In practice, and more specifically, these splitters are placed in large cabins with the corresponding frames, in which are fitted printed circuit cards with the corresponding electrical components such as transformers, inducers, capacitors, resistances, connectors, etc. which can filter the incoming signals depending on the desired output.

Specifically, and as shown in FIG. 1, in the state of the art the filter cards (1) incorporate a card edge connector (2) with normally open contacts, and are connected through a printed circuit board (3) to a first connector (4) located on the rear of the frames (5), all of these located in the splitter zone. From the rear area of the frames (5), these are linked to the corresponding distributors by a second connector (6) and a cable (7), where the conventional connection strips are provided, either open or closed.

As mentioned before, card edge connector (2) has normally open contacts, so that its operation is similar to that of open contact strips allowing connection of the data signal independent of the usual voice signal. The disadvantage of this is that in the event of a failure requiring to repair the card the user is unable to operate, albeit for a short time, as there are no available voice or data input signals until the card (1) is replaced by a new one, in order to repair the former.

In addition, the cards employed always include more than one filter, that is there are cards with “n+1” filters, so that for a single user requiring the signal at least an n+1 filter card must be fitted, thereby having n filters unused until more users enter, with the resulting financial and material cost.

In addition, when one of the aforementioned filters malfunctions, and if more than one user employs it already the entire board must be removed, leaving the other users without service until it is repaired, or secondary boards must be available, with the implied cost.

The large size of the cabins which contain the filter circuits and their connections implies that specific areas are devoted to them as large cubicles which are always removed from the distribution area, with the resulting increase in cost due to land area required, materials, wiring, etc.

### SUMMARY OF THE INVENTION

The object of the invention is to simplify installations and connections, mainly in the areas devoted to filters or splitters, with the resulting positive repercussion from the point of view of both investment and space.

For this purpose and more specifically, one of the improvements of the invention consists of eliminating the open contact card edge connector, the aforementioned printed circuit board and its corresponding connectors, by performing the connections exclusively through closed contact connection strips, which in addition to implying a great simplification of the installation implies that in the event of a malfunction it would suffice to extract the corresponding card, maintaining the voice signal connection for the user, and thereby not leaving the user without service, cutting off the data signal at this time.

Due to the simple connections additional frame fronts and mechanisations are avoided, requiring only a very simple rear frame for supporting the strips, thereby reducing the space required for it and allowing installation in the areas meant for nearby distributors, before the horizontal distributors in charge of distribution and operability of the telephone lines.

The use of said contact strip according to the invention further allows to use individual filter cards or for a single user, simplifying their extraction for repair in the event of a failure without leaving the rest of users without service.

All of this allows in addition to connect individual filter cards to the strips in the areas meant for the horizontal distributors, by fitting a simple wiring in the cards themselves.

### DESCRIPTION OF THE DRAWINGS

These and further characteristics of the present invention will become apparent in view of the accompanying drawings of a preferred embodiment, where for purposes of illustration only the following is shown:

FIG. 1 shows a schematic representation of the conventional technique for connection of wideband filters.

FIG. 2 shows a scheme similar to FIG. 1 but with the connections performed in accordance with the present invention.

FIG. 3 shows a sectional enlarged view of one of the closed contacts which are used to connect the filters as disclosed by the invention.

FIG. 4 shows a schematic representation of one of the individual filter cards as disclosed by the invention.

### PREFERRED EMBODIMENTS OF THE INVENTION

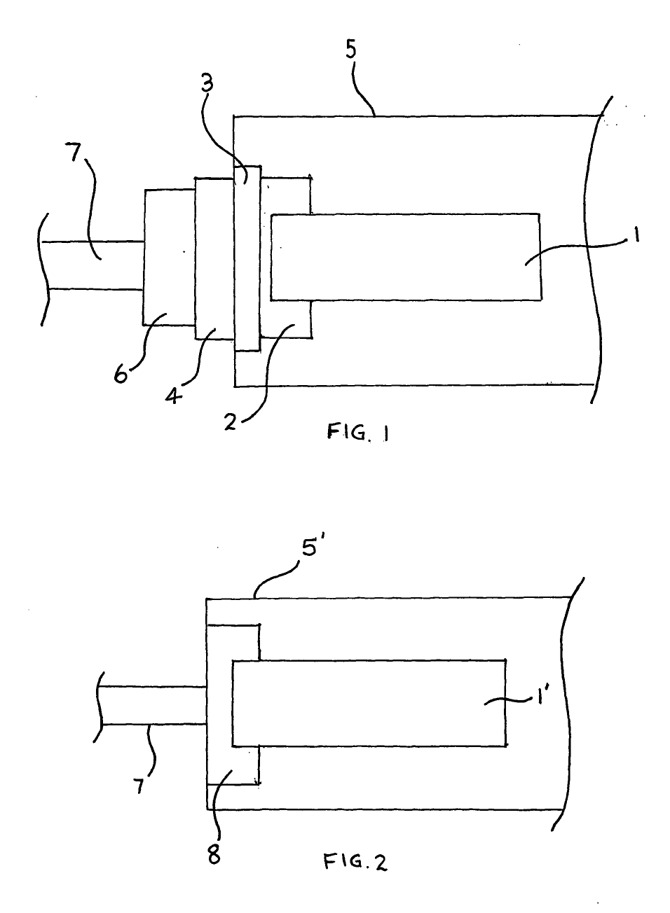

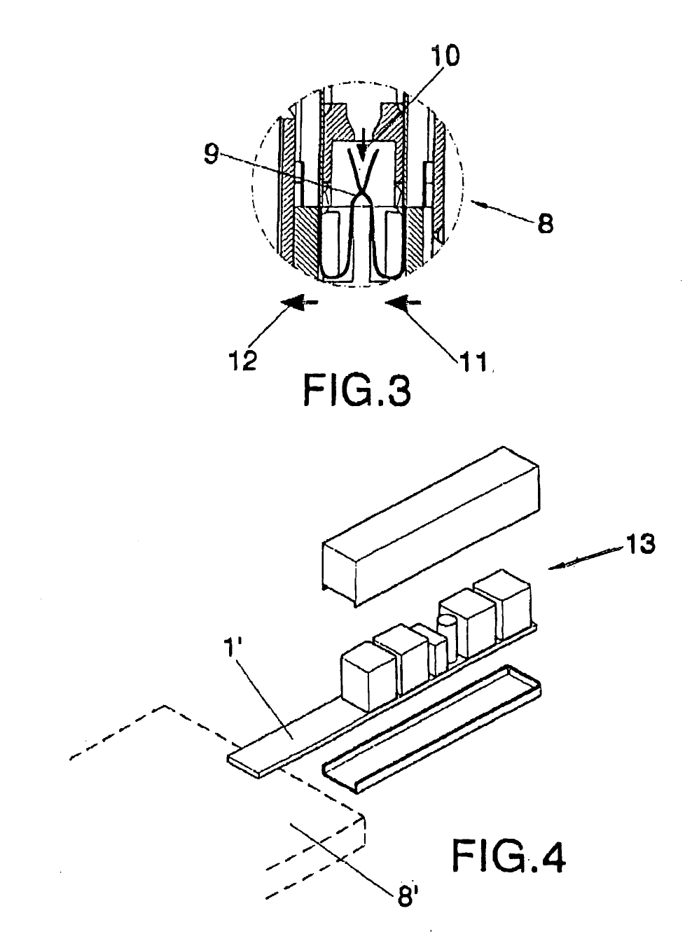

As opposed to the conventional connection of filters shown in FIG. 1, which has been described above, according to one of the embodiments of the invention the filter card (1′) is related to the corresponding connection cable (7) by a single contact strip (8), specifically a closed contact strip as shown in FIG. 3.

This solution implies, as is apparent in view of FIGS. 1 and 2, the elimination of the conventional printed circuit board (3) and of its complementary connectors (4) and (6), as well as the elimination of the card edge connector (2) and the possible replacement of the original frame (5) by a new frame (5′) which can be considerably smaller. That is, by virtue of the simplicity of these connections the large frames required to hold conventional cards are eliminated, as well as the numerous connectors and a great deal of mechanisation, all very costly, and maintaining only a rear frame (5′), which by drastically reducing the space required allows in addition its installation in the areas meant for nearby distributors, before the horizontal distributors.

As shown in FIG. 3, the contact strip (8) tends to keep its contacts (9) permanently closed, so that when there is a malfunction in the data signal represented by the arrow (10) it is enough to extract the corresponding card, maintaining connection between the input (11) of the voice signal for the user and the corresponding output (12), that is without leaving the user without voice signal service.

As shown in FIG. 4, on the filter unit (13) and on a multiple strip (8′) with closed contacts are established a number of individual filter cards (1′), that is, one for each user, which allow their individual extraction for repair in the event of a malfunction or unforeseen event without leaving other users without service.

In order to allow connection of the individual filter cards, (1′) to the strips located in the areas meant for the horizontal distributors a simple wiring is provided on the cards (1′).

It will be understood by those skilled in the art that the present invention is not limited to the embodiments shown and that many additions and modifications are possible without departing from the scope of the present invention as defined in the appending claims.

1. Connecting arrangement for wideband filter installations and connections, in which the filter cards are provided with a card edge connector to a printed circuit board from which, with the aid of another connector pair, the corresponding connection is established to the wiring, wherein the card edge connector, the printed circuit board, the connector and the connector provided in the large frame are replaced by a single contact strip which directly receives the filter card and connects them to the wiring in a small frame or in the areas meant for nearby distributors before the horizontal distributors.

2. Connecting arrangement according to claim 1, wherein the contact strip has closed contacts and has a data input, a voice input and an output which combines the two input signals, so that in the event of a failure in the data input when the corresponding card is extracted the connection is maintained between the voice input and the output.

3. Connecting arrangement according to claim 1 wherein the filter cards employed are cards for a single user, so that they can be handled in the event of a malfunction without leaving other users without service.

4. Connecting arrangement according to claim 3 wherein the filter cards have a simple wiring meant to allow their connection to the contact strips located in the area of the horizontal distributors.

5. A connecting arrangement for a wideband filter on telecommunications lines mounted on a frame that receives voice signals from a first source and wideband data signals from a second source and provides the voice signals and/or wideband data signals to a user over a customer loop of the user, the arrangement comprising:
a contact strip coupled to the frame and configured to removably receive a circuit including the wideband filter, the contact strip including contacts that electrically couple the voice signals from the first source to the user when the circuit is not received in the contact strip.

6. The connecting arrangement of claim 5 wherein the contacts include a first contact coupled to the voice signals from the first source and a second contact adjacent the first contact coupled to the user and wherein the circuit is positioned between first and second contacts when received in the contact strip and wherein the first contact and second contact are electrically connected when the circuit is not received in the contact strip.

7. The connecting arrangement of claim 6 wherein the circuit comprises a filter card.

8. The connecting arrangement of claim 7 wherein the filter card comprises a single user filter card and wherein the contacts comprise a plurality of contact pairs, each configured to receive a single user filter card.

9. The connecting arrangement of claim 6 further comprising wiring directly connected to the contact strip that couple the contact strip to the voice signals from the first source and the user.

10. The connecting arrangement of claim 9 wherein the wiring extends from a rear area of the frame.

11. The connecting arrangement of claim 10 wherein the contact strip is mounted to the rear area of the frame.

12. The connecting arrangement of claim 11 further comprising a plurality of contact strips mounted to the rear area of the frame.

13. The connecting arrangement of claim 6 wherein the circuit further comprises wiring that electrically couple the voice signals from the first source and/or the wideband data signals to the user when the circuit is received in the contact strip.

14. A method for connecting a wideband filter on telecommunications lines at a frame that receives voice signals from a first source and wideband data signals from a second source and provides the voice signals and/or wideband data signals to a user over a customer loop of the user, the method comprising:
electrically connecting the voice signal from the first source to a first contact of a contact strip coupled to the frame, wherein the contact strip is configured to removably receive a circuit including the wideband filter;
electrically connecting the customer loop of the user to a second contact of the contact strip, wherein the first contact and the second contact are electrically connected when the circuit is not received in the contact strip;
inserting a circuit including the wideband filter into the contact strip between the first contact and the second contact, wherein the wideband data signals and/or the voice signals from the first source are coupled to the customer loop of the user through the circuit when the circuit is inserted in the contact strip.
